(19) United States
(12) Patent Application Publication
(10) Pub. No.: US 2012/0281126 A1
(43) Pub. Date: Nov. 8, 2012

(54) DIGITAL INTEGRATION SENSOR

(76) Inventor: Eric R. Fossum, Wolfeboro, NH (US)

(21) Appl. No.: 13/441,906

(22) Filed: Apr. 8, 2012

Related U.S. Application Data
(60) Provisional application No. 61/474,258, filed on Apr. 11, 2011.

(51) Int. Cl. H04N 5/335

(52) U.S. Cl. 348/302; 348/E05.091

(57) ABSTRACT

Multiple scans of a digital integration image sensor are combined to form an output image. The sensor scans or portions thereof may be positionally-shifted relative to one another, and may be acquired in uniform or non-uniform exposure intervals. Selected pixels within at least one of the scans may be excluded from the combination. The scans may also be non-uniformly weighted prior to being combined, with the scan weighting profile corresponding to the scan order.

### CROSS-REFERENCE TO RELATED APPLICATIONS

This application hereby claims priority to and incorporates by reference U.S. Provisional Application No. 61/474,258, filed Apr. 11, 2011 and entitled “DIGITAL INTEGRATION SENSOR.”

### TECHNICAL FIELD

This application relates to the field of image acquisition and processing.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an embodiment of a digital integration sensor;

FIG. 2 illustrates an image formation technique in which multiple positionally-shifted sensor scans are added to produce an output image;

FIG. 3 illustrates an image formation technique in which multiple sensor scans acquired in respective non-uniform exposure intervals are combined to form an output image, with information from selected pixels within at least one of the scans being excluded from the combination;

FIG. 4 illustrates an image formation technique in which multiple sensor scans acquired in respective uniform exposure intervals are non-uniformly weighted and then combined to form an output image;

FIG. 5 illustrates an image formation technique in which multiple sensor scans acquired in respective non-uniform exposure intervals are non-uniformly weighted and then combined to form an output image; and

FIG. 6 illustrates an exemplary non-uniform scan weighting profile in which mid-sequence scans being weighted higher than those at the beginning or end of the sequence.

### DETAILED DESCRIPTION

At least two major difficulties are associated with shrinking pixel technology. These are reduced light on the pixel and reduced full well. Some embodiments of the present disclosure address the full well problem and dynamic range and are applicable to front-side and backside illuminated devices.

To date, most imaging sensors, CCD and CMOS, take an image by integrating a photogenerated carrier signal for some period T which is then followed by readout. The photocarrier signal is integrated in a potential well which is implemented as either a pn-junction capacitor or a buried pn-junction such as the pinned photodiode. The highest performing structure, the pinned-photodiode field-effect device is used with both CCD and CMOS image sensors. The capacity of the storage area is determined by the doping of the pinned photodiode in x, y and z dimensions, and the potential of the adjacent transfer gate. Many tradeoffs can be made in such a structure including the pinned photodiode potential when empty, and its full-well signal, versus transfer gate on and off voltages, as well known to those skilled in the art.

In normal designs, the output amplifier is designed to have a voltage swing that can accommodate the full well signal charge. This depends on the design of the amplifier, its biasing, and its reset, among other factors.

The dynamic range (DR) is an important metric for image sensors. It is the ratio of the full well signal V_{fw} to the r.m.s. noise vₙ under dark conditions and measured in dB as 20 log₁₀(V_{fw}/vₙ). The conversion gain C_{g} of photocarriers to volts (V/e−) is another important metric.

Consider an image sensor with a full well of 3000 e−, and a dark read noise (under correlated double sampling) of 3 e− r.m.s. It has dynamic range of 1000 or 60 dB. If a 10b analog-to-digital converter (ADC) is used, and the maximum range adjusted to correspond to 3000 e−, the LSB resolution is about equal to the dark noise. In this report, we will say that a sensor with dynamic range D requires an ADC with resolution D, or log₂(D) bits for simplicity.

One problem faced by shrinking pixel size is maintaining adequate full well. The area shrinks as the square of pixel pitch. The maximum rail voltage also tends to drop with the decreasing technology node used to implement shrunk pixels. When considering all three spatial dimensions, maintaining full well is difficult as edge and corner effects can also dominate device behavior. Much effort has gone into increasing full well with small pixel pitch.

As will be understood in view of the ensuing disclosure, some embodiments of the present invention are well suited for providing a solution to the problem of shrinking full well and consequent reduction of dynamic range.

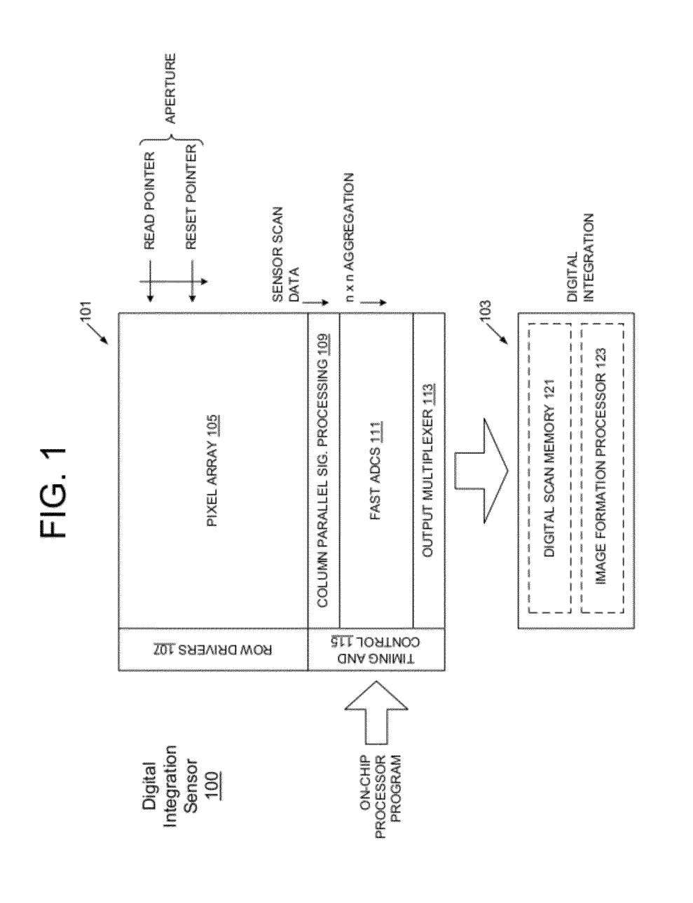

In accordance with some embodiments of an image capture concept in accordance with some aspects of the present disclosure, there is, as shown within digital integration sensor 100 of FIG. 1, a sensor 101 with small CMOS active pixels disposed within a pixel array 105 with a pitch less than about 1000 nm. The sensor includes row drivers 107 that enable reading and resetting of rows of pixels indicated by a read pointer and reset pointer, respectively, with the time delay between resetting and reading defining an aperture of the sensor.

Column-parallel signal processing circuitry 109 receives sensor scan data from the pixel array and operates in conjunction with fast analog-to-digital-converters (ADCs) 111 to deliver an n×n aggregation to output multiplexer 113. As shown, timing and control logic 115 controls the operation of the column-parallel signal processing circuitry, fast ADCs and output multiplexer in response to an on-chip processor program.

The full well of the pixels, including output amplifier and signal chain, is less than 3000 photogenerated carriers but more than one electron (assumed to be electrons but reversing polarity and using holes would be apparent to anyone skilled in the art). In addition to the sensor 101, there is a full-frame memory (digital scan memory 121) for accumulating multiple frames (more than one) of signal from the pixels (i.e., received via output multiplexer 113). This memory 121 may be implemented on a separate chip or may be integrated on-chip with the sensor 101, which is technologically possible. In addition to sensor 101 and memory 121, there is an image formation processor 123 (IFP). The purpose of the image formation processor is to combine data from two or more full scans of the sensor into a single output image. Though shown at 103 as being integrated with memory 121, the IFP 123 may be a separate integrated circuit or integrated on chip with the sensor 101 or memory 121 or both.

The full scan rate of the sensor is faster than the output image rate of the image capture system. For example, for 60 frames per second, the sensor would have a full scan rate greater than 60 full scans per second to capture at least two scans. These two scans would be processed using the memory along with the image formation processor to form an output image.

Since the image is formed by the digital integration of multiple scans of the sensor, the image capture concept presented here is named “Digital Integration Sensor” or DIS.

One illustrative method of image formation is to add 2 or more full scans from the sensor each with pixel integration times whose sum is T or less.

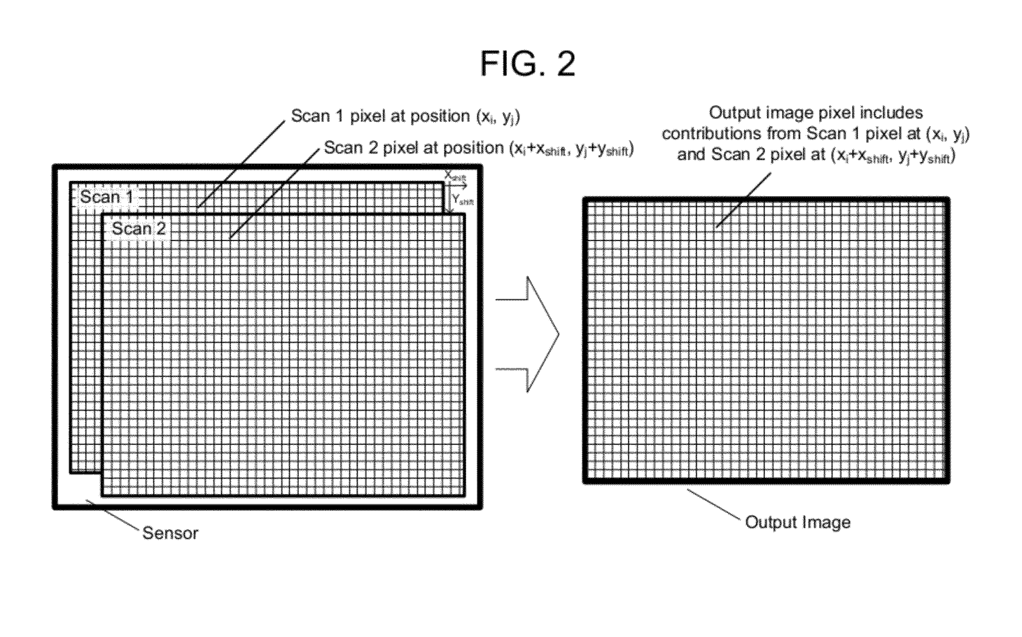

A second illustrative method of image formation is to add multiple sensor scans that are shifted in x-y position (e.g., x only or y only or both x and y) from each other. Such a formation method, depicted for example in FIG. 2 (showing shift in both the x and y directions), might be useful for reducing motion blur due to camera motion or object motion. In this method, the shift between frames could be determined either by external sensor (e.g. gyro or inertial sensor) or from motion flow between scans as analyzed by the image formation processor. This second method might also be useful for emulating “Time Delay and Integration” or TDI often used in CCDs for scanning applications. Another application of this method would be for removing “twinkle” or other imaging artifacts produced by changing media between the object and camera such as the atmosphere.

A third illustrative method of image formation is to combine multiple sensor scans where each separate scan may be warped or shifted or both from the other scans used to form the image.

In the DIS, dynamic range can be increased beyond that obtainable in conventional image sensors. For high illumination conditions, the scan rate could be adjusted to a high rate and the equivalent full well would be proportionally increased. For example, for a full well of only 1000 electrons, a 10× scan rate (e.g. 600 scans per second) would yield an equivalent full well of 10×1000=10,000 electrons, substantially larger than 3,000 electrons in the above example.

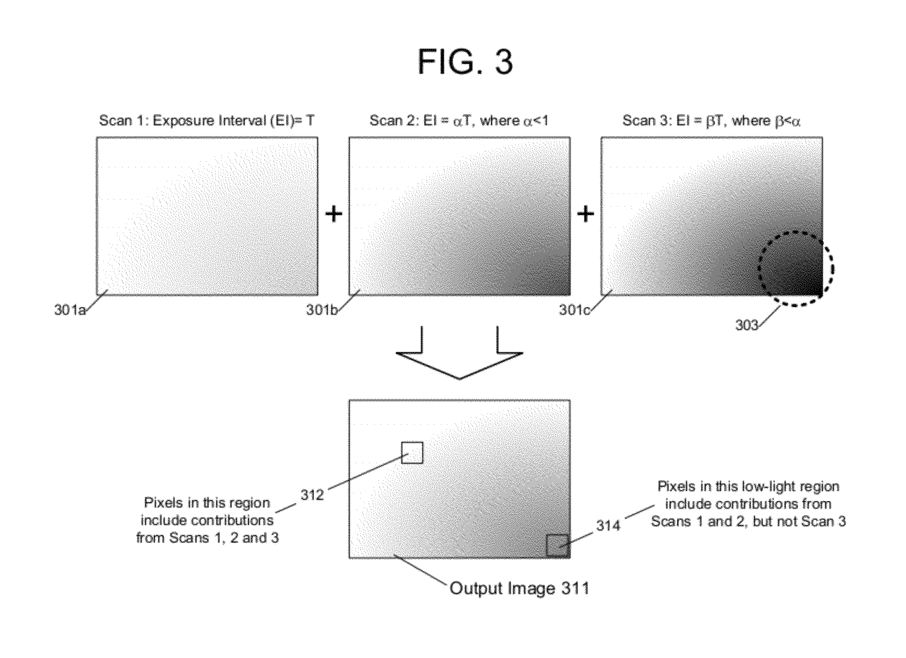

Each scan of a set used for image formation need not have the same individual integration period. It is known in the art that adding multiple scans with different integration periods can be used to increase dynamic range. In the IFP, the scans can be combined to produce a high dynamic range image. Dynamic adjustment of mapping is known in the art to allow adaptable dynamic range imaging. In accordance with some embodiments of the DIS, low light regions of the image need not be summed with shorter integration times dependent on the image data. In this way, extra read noise from multiple scans need not be introduced into low light areas of the image. An example of this approach is shown in FIG. 3, which illustrates three scans 301a, 301b, 301c acquired over non-uniform exposure intervals T, αT and βT, respectively. Because T>αT>βT, the scans are progressively less exposed and thus progressively darker (i.e., accumulating less light over progressively shorter exposure intervals), with scan 301c having a dark or near-dark region in the lower right corner (i.e., at 303). As shown, while pixels in region 312 of output image 311 include contributions from scans 301a, 301b and 301c (i.e., pixel values from each of the three scans contributes to the summation of correspondingly located pixels within output image 311), pixels in region 314 of output image 311 include contributions from scans 301a and 301b, but exclude contributions from scan 301c, thus avoiding read noise from the low light area of that scan. Note that the scan interval progression shown (i.e., from longer exposure interval T to progressively shorter exposure intervals αT and βT) is presented for purposes of example only. Other scan interval progressions (e.g., from shorter to longer, longest mid-sequence, shortest mid-sequence, etc.) may be used in alternative embodiments or configurations.

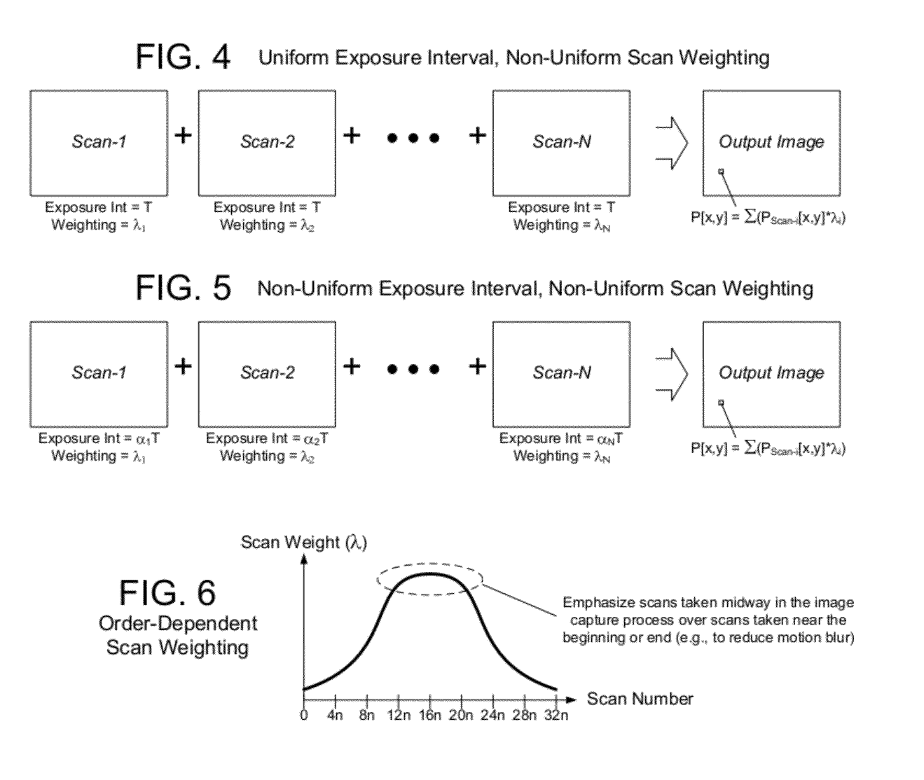

In accordance with some embodiments of a DIS, pixels created by the IFP need not be uniformly weighted in x-y or time. For example, if the scans are of equal integration duration, each scan could be weighted prior to summation to emphasize the scan taken midway in the image capture process over scans take near the beginning or end of the process. FIG. 4 illustrates a generalized example of this approach, with pixels from respective scans 1 through N (each acquired over a respective exposure interval T) being non-uniformly weighted before being summed to form a corresponding pixel of an output image. That is, a given output image pixel at location x,y (P[x,y]) is formed, at least in part, by summation of weighted pixels from a corresponding location within respective scans 1 through N (i.e., ΣP_{scan-i}[x,y]*λᵢ, where summation index ‘i’ ranges from 1 to N, “λᵢ” is the weighting factor applied to the pixel from scan ‘i’, and ‘*’ denotes multiplication). FIG. 5 illustrates a further generalized approach in which the individual scans 1 through N may have non-uniform exposure intervals (i.e., α₁T, α₂T, . . . , α_{N}T) and in which pixels from those scans provide non-uniformly weighted contributions to pixels of the output image. FIG. 6 illustrates an exemplary non-uniform scan weighting profile, with mid-sequence scans being weighted higher than those at the beginning or end of the sequence as mentioned above. This could be used, for example, to reduce motion blur artifacts. In some implementations, images with output resolution lower than the captured spatial resolution can be formed by either binning pixels over some fixed neighborhood, or the image can be formed by convolving the data with a non-rectangular weighting function. Such image formation might be useful when the individual pixel pitch is beyond the diffraction limit for the imaging optics or for color processing.

In accordance with some embodiments of a DIS, the ADC required for scanned readout can have less resolution that that of conventional image sensors. The reduced resolution increases noise margin and reduces power. This compensates for faster scan operation. For example, if the full well is 768 electrons and the read noise 3 e− rms, the ADC can be 8 bits instead of 10 bits for a full well of 3000 electrons. In accordance with various embodiments, the full well size and ADC resolution may be varied according to the implementation. In such embodiments, the data is multi-valued with at least 2 bits of information per pixel per scan.

Reduced full well can also lead to improved noise performance. Pre-ADC gain, including conversion gain, can be increased since the signal swing from a lower full well might normally be less. The result of increased conversion gain, for example, can be lower effective read noise and better low light performance.

Color can be achieved as in conventional image sensors. In the case of very small pixel pitch, below the diffraction limit, small neighborhoods of same-color pixels can be implemented to reduce color cross talk in very small pixels.

Background art that might be considered germane for the DIS includes known motion deblurring and anti-shake strategies involving multiple frames. One fundamental difference with various embodiments of the DIS is the regular assumed use of multiple scans to create a single output image, and the allowance for dynamic range capture greater than a single scan with limited full well would allow.

As described above, known art also exists for multiple integration cycles of varied length to increase dynamic range. In various embodiments of the DIS, full flexibility exists for making scans of equal integration duration and variable duration. Furthermore, known multiple integration cycle techniques only contemplate making perhaps 4 different scan periods (in practice, 2) whereas embodiments of DIS may employ at least 2 and usually more. Additionally, known art describes data that arrives from the sensor in non-sequential row order, with the row order jumping forward and backward. In various embodiments of the DIS, the order is always sequential.

The present invention has been illustrated and described with respect to specific embodiments thereof, which embodiments are merely illustrative and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. For instance, except to the extent necessary or inherent in the processes themselves, no particular order to steps or stages of methods or processes described in this disclosure, including the figures, is implied. In many cases the order of process steps may be varied, and various illustrative steps may be combined, altered, or omitted, without changing the purpose, effect or import of the methods described. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that follow.

In this provisional application, the following claims are merely illustrative of some of the subject matter disclosed herein that applicants regard as applicants' invention, and it is understood that the following illustrative claims are representative of some aspects and embodiments of the invention, and are neither representative nor inclusive of all subject matter and embodiments within the scope of the present invention. It is also understood that subject matter and embodiments within the scope of the invention includes method claims corresponding to the following apparatus claims, as well as other claims (e.g., method as well as apparatus) supported by the present disclosure as understood by those skilled in the art.

What is claimed is:

1. An image sensor apparatus comprising:
an array of active pixels to acquire a plurality of frames of image data in respective exposure intervals; and
an image formation processor to receive the plurality of frames of image data from the array of active pixels and to combine the plurality of frames of image data into an output image, including combining a first pixel from a first frame of the plurality of frames of image data with a second pixel from a second frame of the plurality of frames of image data, wherein the first and second pixels are disposed at different pixel positions within the first and second frames, respectively.

2. The image sensor apparatus of claim 1 wherein the first pixel is offset in one dimension relative to the second pixel.

3. The image sensor apparatus of claim 1 wherein the first pixel is offset in two dimensions relative to the second pixel.

4. The image sensor apparatus of claim 1 further comprising a sensor to detect a positional shift, and wherein the first and second pixels are offset relative to one another in their respective frames according to the positional shift.

5. The image sensor apparatus of claim 4 wherein the sensor to detect a positional shift comprises a sensor to detect motion of the image sensor apparatus.

6. The image sensor apparatus of claim 4 wherein the sensor to detect a positional shift comprises a sensor to detect motion of an object that appears in the first and second frames of image data.

7. The image sensor apparatus of claim 1 wherein the image formation processor is additionally to detect a relative shift in position between the image sensor apparatus and an object that appears in the first and second frames of image data, and wherein the first and second pixels are offset relative to one another in their respective frames according to the shift in position.

8. The image sensor apparatus of claim 1 wherein the active pixels of the array have a pitch less than 1000 nm.

9. The image sensor apparatus of claim 1 wherein each of the active pixels in the array has a full well charge capacity of less than about 3000 carriers and more than one carrier.

10. An image sensor apparatus comprising:
an array of active pixels to acquire a plurality of frames of image data in respective exposure intervals; and
an image formation processor to receive the plurality of frames of image data from the array of active pixels and to combine the plurality of frames of image data into an output image, including combining pixels from each of the plurality of frames of image data to form a first pixel of the output image and combining pixels from a subset of the plurality of frames of image data to form a second pixel of the output image, the subset excluding at least one of the plurality of frames of image data acquired in an exposure interval that is different from an exposure interval of at least one other of the plurality of frames of image data.

11. The image sensor apparatus of claim 10 wherein the exposure interval of the at least one of the plurality of frames of image data is shorter than the exposure interval of the at least one other of the plurality of frames of image data.

12. The image sensor apparatus of claim 11 wherein the at least one of the plurality of frames of image data comprises a low-light region and a higher-light region, and wherein the image formation processor to form the first and second pixels of the output image comprises logic to include a pixel from the higher-light region in the combination of pixels corresponding to the first pixel of the output image and to exclude a pixel from the low-light region from the combination of pixels corresponding to the second pixel of the output image.

13. The image sensor apparatus of claim 10 wherein the active pixels of the array have a pitch less than 1000 nm.

14. The image sensor apparatus of claim 10 wherein each of the active pixels in the array has a full well charge capacity of less than about 3000 carriers and more than one carrier.

15. An image sensor apparatus comprising:
an image sensor to acquire frames of pixel data in respective exposure intervals; and
an image formation processor to receive the frames of pixel data from the array of active pixels and to combine the frames of pixel data into an output image, including multiplying corresponding pixel values within respective frames of pixel data by non-uniform weighting factors to produce respective weighted pixel values and combining the weighted pixel values to form a pixel of the output image.

16. The image sensor apparatus of claim 15 wherein the image sensor comprises an array of active pixels and control circuitry to enable the array of active pixels to generate the frames of pixel data during respective exposure intervals of uniform duration.

17. The image sensor apparatus of claim 15 wherein the frames of pixel values are acquired in sequence and wherein the non-uniform weighting factors have values corresponding to the position of the respective frame of pixel values within the acquisition sequence.

18. The image sensor apparatus of claim 17 wherein a portion of the non-uniform weighting factors corresponding to a portion of the frames of pixels acquired at a midpoint within the acquisition sequence have higher values than portions of the non-uniform weighting factors corresponding to portions of the frames of pixels acquired at an end of the acquisition sequence.

19. The image sensor apparatus of claim 17 wherein a portion of the non-uniform weighting factors corresponding to a portion of the frames of pixels acquired at a midpoint within the acquisition sequence have higher values than portions of the non-uniform weighting factors corresponding to portions of the frames of pixels acquired at both ends of the acquisition sequence.

20. The image sensor apparatus of claim 15 wherein the image sensor comprises an array of active pixels having a pitch less than 1000 nm.

21. The image sensor apparatus of claim 15 wherein the image sensor comprises an array of active pixels in which each pixel has a full well charge capacity of less than about 3000 carriers and more than one carrier.

22. A method of operation within an image sensor apparatus, the method comprising:
acquiring a plurality of frames of image data in respective exposure intervals; and
combining the plurality of frames of image data into an output image, including combining a first pixel from a first frame of the plurality of frames of image data with a second pixel from a second frame of the plurality of frames of image data, wherein the first and second pixels are disposed at different pixel positions within the first and second frames, respectively.

23. A method of operation within an image sensor apparatus, the method comprising:
acquiring a plurality of frames of image data in respective exposure intervals; and
combining the plurality of frames of image data into an output image, including combining pixels from each of the plurality of frames of image data to form a first pixel of the output image and combining pixels from a subset of the plurality of frames of image data to form a second pixel of the output image, the subset excluding at least one of the plurality of frames of image data acquired in an exposure interval that is different from an exposure interval of at least one other of the plurality of frames of image data.

24. A method of operation within an image sensor apparatus, the method comprising:
acquiring frames of pixel data in respective exposure intervals; and
combining the frames of pixel data into an output image, including multiplying corresponding pixel values within respective frames of pixel data by non-uniform weighting factors to produce respective weighted pixel values and combining the weighted pixel values to form a pixel of the output image.

25. An image sensor apparatus comprising:
means for acquiring a plurality of frames of image data in respective exposure intervals; and
means for combining the plurality of frames of image data into an output image, including means for combining a first pixel from a first frame of the plurality of frames of image data with a second pixel from a second frame of the plurality of frames of image data, wherein the first and second pixels are disposed at different pixel positions within the first and second frames, respectively.
